(19) United States
(12) Patent Application Publication
(10) Pub. No.: US 2019/0308354 A1
(43) Pub. Date: Oct. 10, 2019

(54) INJECTION MOLDING APPARATUS AND INJECTION MOLDING METHOD

(71) Applicant: Chung Yuan Christian University, Taoyuan City (TW)

(72) Inventors: Shia-Chung Chen, Taoyuan City (TW); Yung-Hsiang Chang, Taoyuan City (TW); Ying-Fan Lou, Taoyuan City (TW)

(73) Assignee: Chung Yuan Christian University, Taoyuan City (TW)

(21) Appl. No.: 16/016,678

(22) Filed: Jun. 25, 2018

(30) Foreign Application Priority Data
Apr. 10, 2018 (TW) 107112325

(51) Int. Cl. B29C 45/77; B29C 45/76; B29C 45/78

(52) U.S. Cl. CPC B29C 45/77; B29C 45/762; B29C 45/78; B29C 2945/76006; B29C 2945/7604; B29C 2945/76561; B29C 2945/76257; B29C 2945/76381; B29C 2945/76498; B29C 2945/76531; B29C 2945/76173

(57) ABSTRACT

An injection molding apparatus including a mold, an injection device and a specific volume sensing module is provided. The injection device is adapted to inject a material into the mold. At least parts of the specific volume sensing module are disposed at the mold, wherein the specific volume sensing module is adapted to sense an actual specific volume of the material in the mold. In addition, an injection molding method is also provided.

### CROSS-REFERENCE TO RELATED APPLICATION

This application claims the priority benefit of Taiwan application serial no. 107112325, filed on Apr. 10, 2018. The entirety of the above-mentioned patent application is hereby incorporated by reference herein and made a part of this specification.

### BACKGROUND

### Technical Field

The disclosure relates to a molding apparatus and a molding method, and particularly relates to an injection molding apparatus and an injection molding method.

### Description of Related Art

Injection molding is a process of manufacturing parts made of thermoplastic plastic or thermosetting plastic. A plastic material in a cylinder of an injection molding machine is heated and melted to be in a flowing state. Then under the pressure of a plunger or a screw stem, the plastic material is compressed and moved forward so as to pass through a nozzle at the front of the cylinder to be rapidly injected into a closed mold with a lower temperature. After a period of cooling and setting, the mold is then opened, and thus is obtained an injection molding product.

In the process of injection molding, factors such as an injection pressure, a temperature of the mold, a pressure holding time and an environmental temperature all affect the specific volume of the plastic material in the mold, and the quality of the injection molding product depends on whether or not the specific volume of the plastic material may measure up to expectations. In the case of an existing injection molding machine, the quality of the injection molding product may be roughly estimated through sensing the pressure of the plastic material and the temperature of the mold, and an injection parameter may accordingly be adjusted based on the operator's experiences. However, if the actual specific volume of the plastic material cannot be known for sure, it would be impossible to accurately perform the aforementioned adjustment.

### SUMMARY

This disclosure provides an injection molding apparatus and an injection molding method that improve the quality of injection molding products.

The injection molding apparatus of this disclosure includes a mold, an injection device and a specific volume sensing module. The injection device is adapted to inject a material into the mold. At least parts of the specific volume sensing module are disposed at the mold, wherein the specific volume sensing module is adapted to sense an actual specific volume of the material in the mold.

In an embodiment of the disclosure, the specific volume sensing module includes at least one pressure sensing component and at least one temperature sensing component, the at least one pressure sensing component is disposed at the mold and is adapted to sense a pressure of the material in the mold, and the at least one temperature sensing component is disposed at the mold and is adapted to sense a temperature of the material in the mold.

In an embodiment of the disclosure, the specific volume sensing module includes a processor. The processor is coupled to the at least one pressure sensing component and the at least one temperature sensing component, and is adapted to calculate the actual specific volume of the material in the mold according to the pressure of the material in the mold and the temperature of the material in the mold.

In an embodiment of the disclosure, the at least one pressure sensing component is plural in number and the at least one temperature sensing component is plural in number. The plurality of pressure sensing components respectively correspond to a plurality of positions of the mold so as to respectively sense the pressure of the material in the mold that correspond to the plurality of positions, and the plurality of temperature sensing components respectively correspond to the plurality of positions of the mold so as to respectively sense the temperature of the material in the mold that correspond to the plurality of positions.

In an embodiment of the disclosure, an inner surface of the mold faces the material in the mold, and the at least one temperature sensing component is disposed at the inner surface of the mold.

In an embodiment of the disclosure, an inner surface of the mold faces the material in the mold, the mold has a through-hole extending from an outer surface of the mold to the inner surface of the mold, and the at least one pressure sensing component is disposed at the outer surface of the mold and corresponds to the through-hole.

In an embodiment of the disclosure, an inner surface of the mold faces the material in the mold, and the at least one temperature sensing component and the at least one pressure sensing component are integrated into a sensor that is disposed at the inner surface of the mold.

In an embodiment of the disclosure, the injection molding apparatus includes a controller. The controller is coupled to the specific volume sensing module, and is adapted to adjust at least one injection molding parameter of the injection molding apparatus according to the actual specific volume of the material in the mold.

In an embodiment of the disclosure, the at least one injection molding parameter includes an injection pressure of the injection device, a temperature of the mold, and a pressure holding time performed by the injection device.

In an embodiment of the disclosure, during the process in which the injection device injects the material into the mold, the specific volume sensing module is adapted to sense the actual specific volume of the material in the mold many times at a predetermined time interval.

The injection molding method of this disclosure is provided hereinafter. A material is injected into a mold by an injection device, and an actual specific volume of the material in the mold is sensed by a specific volume sensing module.

The injection molding method in an embodiment of the disclosure is provided hereinafter. A pressure of the material in the mold is sensed by at least one pressure sensing component, and a temperature of the material in the mold is sensed by at least one temperature sensing component.

The injection molding method in an embodiment of the disclosure is provided hereinafter. The actual specific volume of the material in the mold is calculated by a processor according to the pressure of the material in the mold and the temperature of the material in the mold.

In an embodiment of the disclosure, the at least one pressure sensing component is plural in number and the at least one temperature sensing component is plural in number, and the injection molding method herein is provided hereinafter. The pressure of the material in the mold that correspond to a plurality of positions is respectively sensed by the plurality of pressure sensing components, and the temperature of the material in the mold that correspond to the plurality of positions is respectively sensed by the plurality of temperature sensing components.

The injection molding method in an embodiment of the disclosure is provided hereinafter. At least one injection molding parameter is adjusted by a controller according to the specific volume of the material in the mold.

In an embodiment of the disclosure, the at least one injection molding parameter includes an injection pressure of the injection device, a temperature of the mold, and a pressure holding time performed by the injection device.

The injection molding method in an embodiment of the disclosure is provided hereinafter. During the process in which the injection device injects the material into the mold, the specific volume of the material in the mold is sensed by the specific volume sensing module many times at a predetermined time interval.

Based on the foregoing, in the case of the injection molding apparatus of this disclosure, by the specific volume sensing module that obtains the actual specific volume of the material in the mold, the injection parameter is accurately adjusted accordingly, thereby improving the quality of the injection molding product.

To make the aforementioned and other features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an injection molding apparatus according to an embodiment of the disclosure.

FIG. 2 is a flowchart showing an injection molding method according to an embodiment of the disclosure.

FIG. 3 is a block diagram of some components of the injection molding apparatus of FIG. 1.

FIG. 4 is a partial schematic view of an injection molding apparatus according to another embodiment of the disclosure.

FIG. 5 is a partial schematic view of an injection molding apparatus according to another embodiment of the disclosure.

FIG. 6 is a partial schematic view of an injection molding apparatus according to another embodiment of the disclosure.

### DESCRIPTION OF THE EMBODIMENTS

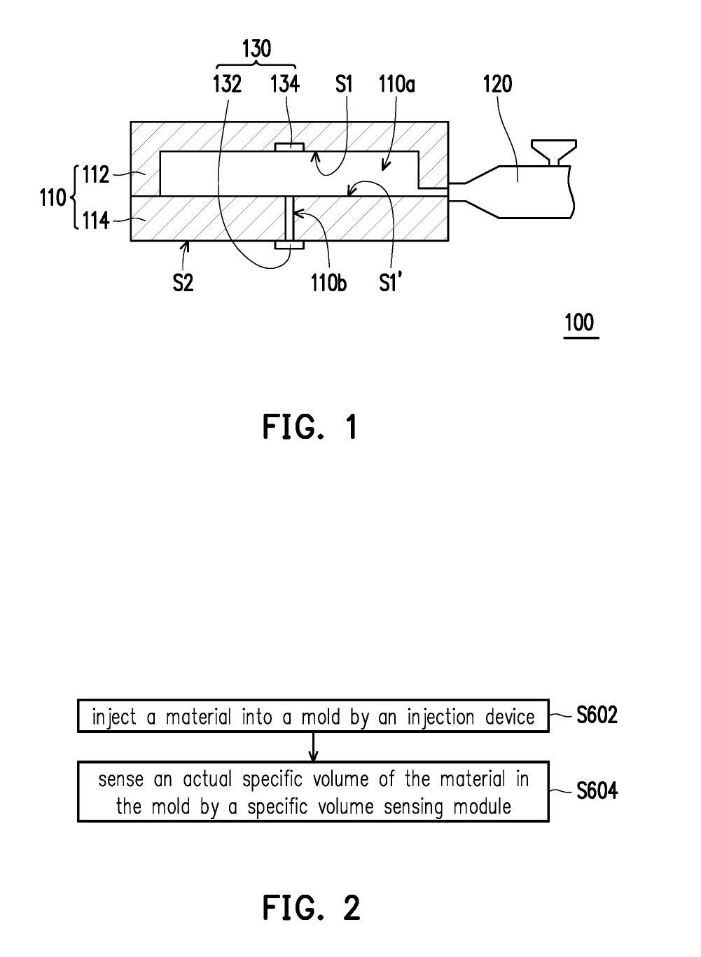

FIG. 1 is a schematic view of an injection molding apparatus according to an embodiment of the disclosure. With reference to FIG. 1, an injection molding apparatus 100 of this embodiment includes a mold 110, an injection device 120 and a specific volume sensing module 130. The mold 110 is composed of an upper mold 112 and a lower mold 114. As shown in FIG. 1, the upper mold 112 and the lower mold 114, when closed with respect to each other, define a mold cavity 110a. The injection device 120 is adapted to inject a material (such as a plastic material) into the mold cavity 110a of the mold 110. At least parts of the specific volume sensing module 130 are disposed at the mold 110. The specific volume sensing module 130 is adapted to sense an actual specific volume of the material in the mold 110 so that the injection parameter is accurately adjusted, thereby improving the quality of the injection molding product.

Hereinafter, the primary process of an injection molding method according to an embodiment of the disclosure is described with reference to the drawings. FIG. 2 is a flowchart showing an injection molding method according to an embodiment of the disclosure. With reference to FIG. 2, taking the injection molding apparatus 100 shown in FIG. 1 as an example, first of all, a material is injected into the mold 110 by the injection device 120 (step S602). Then, the actual specific volume of the material in the mold 110 is sensed by the specific volume sensing module 130 (step S604).

In detail, as shown in FIG. 1, the specific volume sensing module 130 in this embodiment includes at least one pressure sensing component 132 and at least one temperature sensing component 134. The pressure sensing component 132 is disposed at the lower mold 114 of the mold 110 and is adapted to sense the pressure of the material in the mold 110. The temperature sensing component 134 is disposed at the mold 110 and is adapted to sense the temperature of the material in the mold 110. Specifically, the temperature sensing component 134 is, for example, an infrared sensor (such as a photoresistor), and the temperature sensing component 134 is disposed at an inner surface S1 of the upper mold 112 of the mold 110 that faces the material so as to be capable of directly sensing the temperature of the material in the mold 110. Besides, the mold 110 has a through-hole 110b, and the through-hole 110b extends from an outer surface S2 of the mold 110 to an inner surface S1′ of the lower mold 114 of the mold 110 that faces the material. The pressure sensing component 132 is disposed at the outer surface S2 of the lower mold 114 of the mold 110 and corresponds to the through-hole 110b to directly sense the pressure of the material in the mold 110 by the through-hole 110b. By such configuration, in this embodiment, the temperature sensing component 134 directly senses the temperature of the material in the mold 110 so as to accurately calculate the specific volume value in combination with the pressure value sensed by the pressure sensing component 132. This method is different from the conventional method in which the state of the material is roughly estimated by sensing the temperature of the mold 110 only. In other embodiments, the pressure sensing component 132 and the temperature sensing component 134 may both be disposed at the upper mold 112 or both be disposed at the lower mold 114.

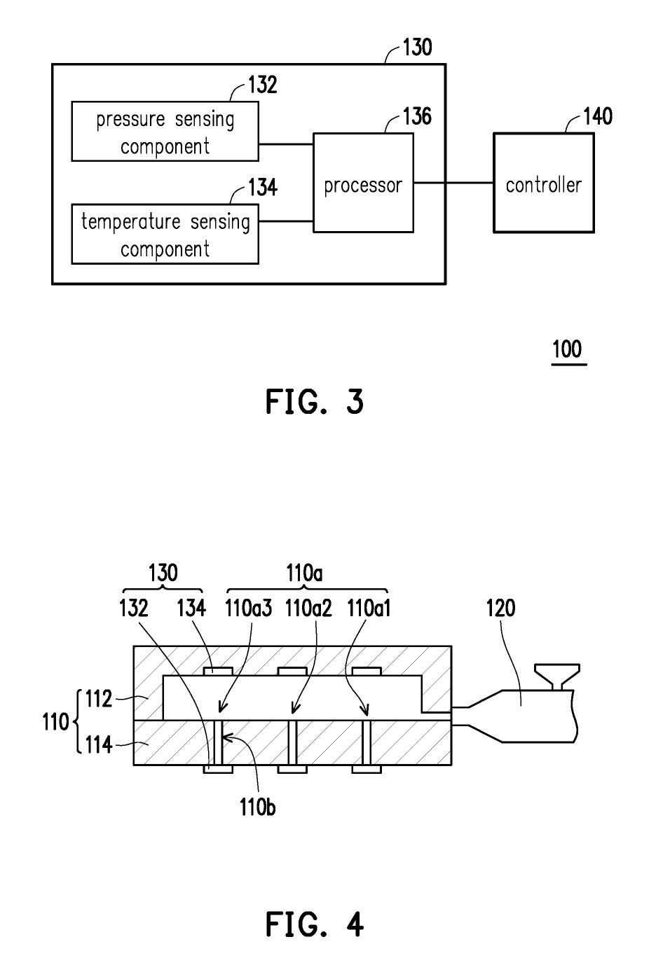

FIG. 3 is a block diagram of some components of the injection molding apparatus of FIG. 1. With reference to FIG. 3, the specific volume sensing module 130 of this embodiment further includes a processor 136. The processor 136 is, for example, a computer or another suitable device with a computing function. The processor 136 is coupled to the pressure sensing component 132 and the temperature sensing component 134, and is adapted to calculate the actual specific volume of the material in the mold 110 according to the pressure of the material in the mold 110 sensed by the pressure sensing component 132 and the temperature of the material in the mold 110 sensed by the temperature sensing component 134. In this embodiment, the pressure value sensed by the pressure sensing component 132 and the temperature value sensed by the temperature sensing component 134 may be stored in a data acquisition card (DAQ card) and then be transmitted to the processor 136. Herein, a signal amplifier may be used to amplify the temperature value signal sensed by the temperature sensing component 134. In addition, the pressure value, the temperature value and the specific volume value may be displayed on a display interface for the operator to see.

With reference to FIG. 3, to be more specific, the injection molding apparatus 100 of this embodiment further includes a controller 140. The controller 140 is, for example, a computer or another suitable device with a control function. The controller 140 is coupled to the processor 136 of the specific volume sensing module 130, and is adapted to adjust an injection molding parameter of the injection molding apparatus 100 according to the actual specific volume of the material in the mold 110 calculated by the processor 136. The injection molding parameter may include an injection pressure of the injection device 120, a temperature of the mold 110, and a pressure holding time performed by the injection device 120. The pressure holding refers to the state in which the injection device 120, after injecting the material into the mold 110, continues to apply appropriate injection pressure to provide a proper amount of materials into the mold 110 until the materials in the mold 110 are solidified. As a result, the shrinkage of the materials in the mold 110 during the solidification process that results in an undesired size of the injection molding product may be prevented.

In this embodiment, during the process in which the injection device 120 injects the material into the mold 110, the specific volume sensing module 130, for example, senses the actual specific volume of the material in the mold 110 many times at a predetermined time interval. For example, the pressure sensing component 132 may be set to sense the pressure of the material in the mold 110 every 0.04 seconds, and the temperature sensing component 134 may be set to sense the temperature of the material in the mold 110 every 0.04 seconds. Accordingly, the processor 136 may calculate the current actual specific volume of the material in the mold 110 every 0.04 seconds, and may continuously and instantly transmit these actual specific volume values to the controller 140 so that the controller 140 may continuously adjust the injection pressure of the injection device 120, the temperature of the mold 110 and the pressure holding time performed by the injection device 120 during the process in which the injection device 120 injects the material into the mold 110. In other embodiments, the time interval may be of a different time length, and the disclosure is not limited thereto. In other embodiments, the controller 140 may further adjust the parameter of the next injection molding process according to the actual specific volume of the material in the mold 110. In addition, in other embodiments, the injection molding apparatus 100 may not have a controller, and after the processor 136 calculates the actual specific volume of the material in the mold 110, the operator may manually adjust the parameter accordingly.

The shape of the mold cavity 110a of the mold 110 and the configuration of the pressure sensing component 132 and the temperature sensing component 134 as shown in FIG. 1 are only schematic examples, and variations thereof are described hereinafter with reference to the drawings.

FIG. 4 is a partial schematic view of an injection molding apparatus according to another embodiment of the disclosure. The difference between the embodiment shown in FIG. 4 and the embodiment shown in FIG. 1 is that there are a plurality of pressure sensing components 132 (shown as three) and a plurality of temperature sensing components 134 (shown as three) in FIG. 4. These pressure sensing components 132 respectively correspond to a plurality of positions 110a1, 110a2 and 110a3 of a mold cavity 110a of a mold 110 so as to respectively sense the pressures of the material in the mold 110 that correspond to the positions 110a1, 110a2 and 110a3. Similarly, these temperature sensing components 134 respectively correspond to the positions 110a1, 110a2 and 110a3 of the mold cavity 110a of the mold 110 so as to respectively sense the temperatures of the material in the mold 110 that correspond to the positions 110a1, 110a2 and 110a3. Accordingly, the specific volumes of the material in the mold 110 at the positions 110a1, 110a2 and 110a3 may be calculated so that the parameter is adjusted in a more comprehensive manner.

Specifically, the parameter may be adjusted to achieve a desired value according to the specific volume of the material at the position 110a3, and it is then determined accordingly whether the material at the position 110a3 has solidified or not. After the material at the position 110a3 solidifies, the parameter is adjusted to achieve a desired value according to the specific volume of the material at the position 110a2, and it is then determined accordingly whether the material at the position 110a2 has solidified or not. After the material at the position 110a2 solidifies, the parameter is adjusted to achieve a desired value according to the specific volume of the material at the position 110a1, and it is then determined accordingly whether the material at the position 110a1 has solidified or not. As described above, the parameter is adjusted sequentially and segmentally in correspondence to the material at different positions in the mold 110, thereby ensuring that the specific volumes of the injection molding product at these positions are the same to further improve the quality of the product.

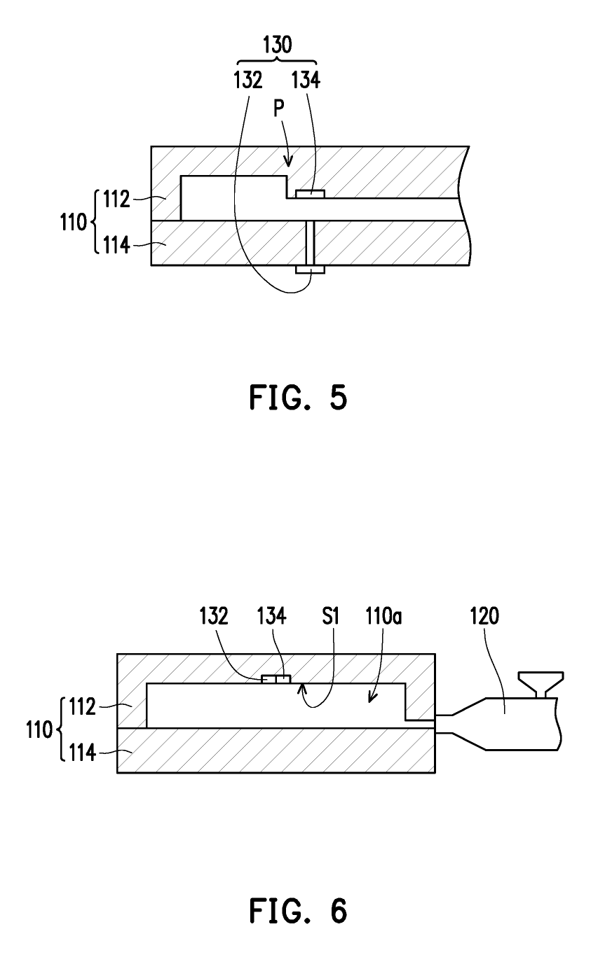

FIG. 5 is a partial schematic view of an injection molding apparatus according to another embodiment of the disclosure. As shown in FIG. 5, there is a significant change in the shape of a mold cavity of a mold 110 at a position P, so that there is a higher probability that the specific volume of the material here is not as expected. Therefore, a pressure sensing component 132 and a temperature sensing component 134 may be disposed at the position P as shown in FIG. 5 to effectively monitor the specific volume of the material here.

FIG. 6 is a partial schematic view of an injection molding apparatus according to another embodiment of the disclosure. In the embodiment shown in FIG. 6, a temperature sensing component 134 and a pressure sensing component 132 are integrated into a sensor that is disposed at an inner surface S1 of a mold 110. In this way, the installation process of the temperature sensing component 134 and the pressure sensing component 132 may be simplified.

Although the embodiments are already disclosed as above, these embodiments should not be construed as limitations on the scope of the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An injection molding apparatus, comprising:
a mold;
an injection device adapted to inject a material into the mold; and
a specific volume sensing module, wherein at least parts of the specific volume sensing module are disposed at the mold, and the specific volume sensing module is adapted to sense an actual specific volume of the material in the mold.

2. The injection molding apparatus as recited in claim 1, wherein the specific volume sensing module comprises at least one pressure sensing component and at least one temperature sensing component, the at least one pressure sensing component is disposed at the mold and is adapted to sense a pressure of the material in the mold, and the at least one temperature sensing component is disposed at the mold and is adapted to sense a temperature of the material in the mold.

3. The injection molding apparatus as recited in claim 2, wherein the specific volume sensing module comprises a processor, wherein the processor is coupled to the at least one pressure sensing component and the at least one temperature sensing component, and is adapted to calculate the actual specific volume of the material in the mold according to the pressure of the material in the mold and the temperature of the material in the mold.

4. The injection molding apparatus as recited in claim 2, wherein the at least one pressure sensing component is plural in number and the at least one temperature sensing component is plural in number, wherein the plurality of pressure sensing components respectively correspond to a plurality of positions of the mold so as to respectively sense the pressure of the material in the mold that correspond to the plurality of positions, and the plurality of temperature sensing components respectively correspond to the plurality of positions of the mold so as to respectively sense the temperature of the material in the mold that correspond to the plurality of positions.

5. The injection molding apparatus as recited in claim 2, wherein an inner surface of the mold faces the material in the mold, and the at least one temperature sensing component is disposed at the inner surface of the mold.

6. The injection molding apparatus as recited in claim 2, wherein an inner surface of the mold faces the material in the mold, the mold has a through-hole extending from an outer surface of the mold to the inner surface of the mold, and the at least one pressure sensing component is disposed at the outer surface of the mold and corresponds to the through-hole.

7. The injection molding apparatus as recited in claim 2, wherein an inner surface of the mold faces the material in the mold, and the at least one temperature sensing component and the at least one pressure sensing component are integrated into a sensor that is disposed at the inner surface of the mold.

8. The injection molding apparatus as recited in claim 1, comprising a controller, wherein the controller is coupled to the specific volume sensing module, and is adapted to adjust at least one injection molding parameter of the injection molding apparatus according to the actual specific volume of the material in the mold.

9. The injection molding apparatus as recited in claim 8, wherein the at least one injection molding parameter comprises an injection pressure of the injection device, a temperature of the mold, and a pressure holding time performed by the injection device.

10. The injection molding apparatus as recited in claim 1, wherein during the process in which the injection device injects the material into the mold, the specific volume sensing module is adapted to sense the actual specific volume of the material in the mold many times at a predetermined time interval.

11. An injection molding method, comprising:
injecting a material into a mold by an injection device; and
sensing an actual specific volume of the material in the mold by a specific volume sensing module.

12. The injection molding method as recited in claim 11, comprising:
sensing a pressure of the material in the mold by at least one pressure sensing component; and
sensing a temperature of the material in the mold by at least one temperature sensing component.

13. The injection molding method as recited in claim 12, comprising:
by a processor, calculating the actual specific volume of the material in the mold according to the pressure of the material in the mold and the temperature of the material in the mold.

14. The injection molding method as recited in claim 12, wherein the at least one pressure sensing component is plural in number and the at least one temperature sensing component is plural in number, the injection molding method comprising:
by the plurality of pressure sensing components, respectively sensing the pressure of the material in the mold that correspond to a plurality of positions; and
by the plurality of temperature sensing components, respectively sensing the temperature of the material in the mold that correspond to the plurality of positions.

15. The injection molding method as recited in claim 11, comprising:
by a controller, adjusting at least one injection molding parameter according to the specific volume of the material in the mold.

16. The injection molding method as recited in claim 15, wherein the at least one injection molding parameter comprises an injection pressure of the injection device, a temperature of the mold, and a pressure holding time performed by the injection device.

17. The injection molding method as recited in claim 11, comprising:
during the process in which the injection device injects the material into the mold, sensing the specific volume of the material in the mold many times at a predetermined time interval by the specific volume sensing module.
